(19) United States
(12) Patent Application Publication
(10) Pub. No.: US 2010/0220124 A1
(43) Pub. Date: Sep. 2, 2010

(54) DRIVING METHOD OF A LIQUID CRYSTAL SUB-PIXEL

(75) Inventors: Yu-Chieh Chen, Taipei County (TW); Chien-Huang Liao, Hsinchu City (TW); Pin-Miao Liu, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/512,011

(22) Filed: Jul. 29, 2009

(30) Foreign Application Priority Data
Feb. 27, 2009 (TW) 98106466

(51) Int. Cl. G09G 5/02

(52) U.S. Cl. 345/694; 345/89

(57) ABSTRACT

A driving method for determining target transmittance of a liquid crystal sub-pixel is provided. The liquid crystal sub-pixel has display regions, the liquid crystal sub-pixel displays the target transmittance when liquid crystal voltage applied to each display region is equal to one other and transmittance variation of liquid crystal layer in the liquid crystal sub-pixel is S₀ when variation of LC voltage ΔV_{LC} occurs. The driving method includes selecting LC voltages in accordance with the target transmittance and area ratio of each display region; and applying each LC voltage to one of the display regions correspondingly, wherein transmittance of each display region is different from the target transmittance, the target transmittance is equal to sum of product of area ratio and transmittance of each display region, and transmittance variation of the liquid crystal layer in the liquid crystal sub-pixel is lower than S₀ when variation of LC voltage ΔV_{LC} occurs.

### CROSS-REFERENCE TO RELATED APPLICATION

This application claims the priority benefit of Taiwan application serial no. 98106466, filed on Feb. 27, 2009. The entirety of the above-mentioned patent application is hereby incorporated by reference herein and made a part of specification.

### BACKGROUND OF THE INVENTION

1. Field of the Invention

The present invention relates to a driving method of a liquid crystal sub-pixel. More particularly, the present invention relates to a driving method of a liquid crystal sub-pixel capable of reducing image sticking problem.

2. Description of Related Art

Due to the superior characteristics of high picture quality, good space utilization, low power consumption, and radiation free, liquid crystal displays has gradually become the mainstream products of display device in the market. Inevitably, charged impurities or ions exist in liquid crystal molecules of the liquid crystal display panel. After a long time operation, distribution of charged impurities or ions is gradually changed and results in deterioration of display quality of the liquid crystal display panel. Specifically, during a long time operation, charged impurities or ions may separate in accordance with polarity thereof After charged impurities or ions are separated in accordance with polarity thereof, the LC voltage V_{LC} applied to the liquid crystal layer is reduced by the charged impurities or ions. Accordingly, variation of LC voltage V_{LC} applied to the liquid crystal layer occurs. The phenomenon is so-call screen effect. Additionally, after charged impurities or ions separated in accordance with polarity thereof, a parasitic potential is generated within the liquid crystal bulk panel and the optimum voltage level of common electrode may vary (V-com shift phenomenon).

Since charged impurities or ions in the liquid crystal layer lead to screen effect and V-com shift phenomenon, image sticking problem (or surface-type image sticking problem) may occur. Accordingly, display quality of the liquid crystal display panel is deteriorated. In order to reduce image sticking problem resulted from charged impurities or ions, more reliable liquid crystal materials or modified fabrication processes are currently adopted to reduce quantity of charged impurities or ions. In addition, image sticking problem may also reduced by modified driving method of the liquid crystal display panel. However, image sticking problem can not significantly reduced by the above-mentioned solutions.

### SUMMARY OF THE INVENTION

A driving method of a liquid crystal sub-pixel, of which is divided into display regions in the number of n, is provided. For any displayed gray level, the transmittance of a liquid crystal layer within the liquid crystal sub-pixel shall have corresponding transmittance T_{sub-pixel}. As the number of display region n in one sub-pixel is 1, the corresponding voltage applied to the display regions is V₀. and transmittance variation of the liquid crystal layer in the liquid crystal sub-pixel is S₀ when variation of liquid crystal voltage ΔV_{LC} occurs. As the number of display region n is larger than 1, the driving method of the liquid crystal sub-pixel includes applying a liquid crystal voltage Vₖ to each of the display regions respectively so that transmittance of the liquid crystal layer within each of the display regions is Tₖ(Vₖ), wherein 1≦k≦n and n≧2. Area of each of the display regions is aₖ such that aₖ and Tₖ(Vₖ) satisfy equation (1);

$$\begin{matrix}{T}_{pixel} = \frac{{\sum }_{k = 1}^{n} {a}_{k} \times {T}_{k} ( {V}_{k} )}{{\sum }_{k = 1}^{n} {a}_{k}} ; & ( 1 ) \\ {S}_{pixel} = \frac{{\sum }_{k = 1}^{n} {a}_{k} \times {S}_{k} ( {V}_{k} )}{{\sum }_{k = 1}^{n} {a}_{k}} < {S}_{0} ; & ( 2 )\end{matrix}$$

When liquid crystal voltage of each of the display regions satisfies equation (1) and variation of liquid crystal voltage ΔV_{LC} occurs, transmittance variation of the liquid crystal layer in each of the display regions is Sₖ(Vₖ), an overall transmittance variation of the liquid crystal layer in the liquid crystal sub-pixel is Sₚᵢₓₑₗ, as well as Sₖ(Vₖ) and Sₚᵢₓₑₗ satisfy equation (2).

In an embodiment of the invention, transmittance Tₖ(Vₖ) of the liquid crystal layer within parts of the display regions is greater than T_{sub-pixel}, transmittance Tₖ(Vₖ) of the liquid crystal layer within the other parts of the display regions is lower than T_{sub-pixel}.

A driving method of a liquid crystal sub-pixel having display regions in the number of n is provided, wherein luminance of gray-level of the liquid crystal sub-pixel is Lₚᵢₓₑₗ when the voltage applied to each of the display regions is V₀ and luminance of gray-level variation of the liquid crystal sub-pixel is X₀ when variation of liquid crystal voltage ΔV_{LC} occurs. The driving method of the liquid crystal sub-pixel includes applying a liquid crystal voltage Vₖ to each of the display regions respectively such that luminance of gray-level of each of the display regions is Lₖ(Vₖ), wherein 1≦k≦n and n≧2. Area of each of the display regions is aₖ such that aₖ and Lₖ(Vₖ) satisfy equation (3);

$$\begin{matrix}{L}_{pixel} = \frac{{\sum }_{k = 1}^{n} {a}_{k} \times {L}_{k} ( {V}_{k} )}{{\sum }_{k = 1}^{n} {a}_{k}} ; & ( 3 ) \\ {X}_{pixel} = \frac{{\sum }_{k = 1}^{n} {a}_{k} \times {X}_{k} ( {V}_{k} )}{{\sum }_{k = 1}^{n} {a}_{k}} < {X}_{0} ; & ( 4 )\end{matrix}$$

when liquid crystal voltage of each of the display regions satisfies equation (3) and variation of liquid crystal voltage ΔV_{LC} occurs, luminance of gray-level variation of each of the display regions is Xₖ(Vₖ), an overall luminance of gray-level variation of the liquid crystal layer in the liquid crystal sub-pixel is Xₚᵢₓₑₗ, as well as Xₖ(Vₖ) and Xₚᵢₓₑₗ satisfy equation (4).

In an embodiment of the invention, luminance of gray-level Lₖ(Vₖ) of parts of the display regions is greater than Lₚᵢₓₑₗ, luminance of gray-level Lₖ(Vₖ) of the other parts of the display regions is lower than Lₚᵢₓₑₗ.

In an embodiment of the invention, liquid crystal voltages V₁, V₂, . . . , Vₙ₋₁, and Vₙ applied to each of the display regions are different from one another, or not identical.

In an embodiment of the invention, areas a₁, a₂, . . . , aₙ₋₁, and aₙ of each of the display regions are different from one another, identical, or not identical.

In an embodiment of the invention, the liquid crystal sub-pixel includes a transmissive liquid crystal sub-pixel, reflective liquid crystal sub-pixel, or a transflective liquid crystal sub-pixel.

In an embodiment of the invention, voltage-transmittance curve of liquid crystal layer within the display regions is different from one another, identical, or not identical.

A driving method for determining a target transmittance of a liquid crystal layer in a liquid crystal sub-pixel is provided, wherein the liquid crystal sub-pixel has a plurality of display regions, the liquid crystal layer in the liquid crystal sub-pixel displays the target transmittance when liquid crystal voltage applied to each of the display regions is equal to one other and transmittance variation of liquid crystal layer in the liquid crystal sub-pixel is S₀ when variation of liquid crystal voltage ΔV_{LC} occurs. The driving method includes: selecting a plurality of liquid crystal voltages in accordance with the target transmittance and area ratio of each of the display regions; and applying each of the liquid crystal voltages to one of the display regions correspondingly, wherein transmittance of each of the display regions is different from the target transmittance, the target transmittance is equal to sum of product of area ratio and transmittance of each display region, and transmittance variation of the liquid crystal layer in the liquid crystal sub-pixel is lower than S₀ when variation of liquid crystal voltage ΔV_{LC} occurs.

A driving method for determining a target luminance of gray-level of a liquid crystal sub-pixel is provided, wherein the liquid crystal sub-pixel has a plurality of display regions, the liquid crystal sub-pixel displays the target luminance of gray-level when liquid crystal voltage applied to each of the display regions is equal to one other and luminance of gray-level variation of the liquid crystal sub-pixel is X₀ when variation of liquid crystal voltage ΔV_{LC} occurs. The driving method includes: selecting a plurality of liquid crystal voltages in accordance with the target luminance of gray-level and area ratio of each of the display regions; and applying each of the liquid crystal voltages to one of the display regions correspondingly, wherein luminance of gray-level of each of the display regions is different from the target luminance of gray-level, the target luminance of gray-level is equal to sum of product of area ratio and gray-level of each display region, and luminance of gray-level variation of the liquid crystal sub-pixel is lower than X₀ when variation of liquid crystal voltage ΔV_{LC} occurs.

Since the present invention selects liquid crystal voltages in accordance with the target luminance of gray-level (or the target transmittance) to be displayed and area ratio of each display region in the liquid crystal sub-pixel and applies each liquid crystal voltage to one of the display regions correspondingly, the liquid crystal sub-pixel is capable of displaying the target luminance of gray-level (or the target transmittance) correctly and is not sensitive to variation of liquid crystal voltage. Accordingly, image sticking problem is effectively reduced.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating a driving method according to the first embodiment of the present invention.

FIG. 2 is a Voltage-Transmittance curve illustrating relationship between voltage V₀ and liquid crystal voltages Vₖ (i.e. liquid crystal voltage V₁ and liquid crystal voltage V₂).

FIG. 3 is a flow chart illustrating a driving method according to the third embodiment of the present invention.

### DESCRIPTION OF EMBODIMENTS

In order to improve the reliability of display quality of the liquid crystal display panel, a plurality of individual display regions are defined in a liquid crystal sub-pixel and proper liquid crystal voltages are applied to the display regions correspondingly such that the liquid crystal sub-pixel can display correct transmittance. From another aspect, in an embodiment of the invention, a plurality of individual display regions are defined in a liquid crystal sub-pixel and proper liquid crystal voltages are applied to the display regions correspondingly such that the liquid crystal sub-pixel can display correct gray-level. Here, the above-mentioned liquid crystal sub-pixel is a red sub-pixel, a green sub-pixel, blue sub-pixel, white sub-pixel, or other types of sub-pixels. In addition, the above-mentioned liquid crystal sub-pixel is a transmissive liquid crystal sub-pixel, a reflective liquid crystal sub-pixel, or a transflective liquid crystal sub-pixel. For example, the display mode of the liquid crystal sub-pixel is TN-mode, VA-mode, IPS-mode, or OCB-mode. In addition, according to physical properties of the liquid crystal layer in the liquid crystal sub-pixel, the liquid crystal layer may be classified into normally white liquid crystal and normally black liquid crystal. The type and display mode of the liquid crystal sub-pixel is not limited in the present invention. Additionally, physical properties of the liquid crystal layer in the liquid crystal sub-pixel are not limited in the present invention.

When determining liquid crystal voltages applied to the display regions, the liquid crystal voltages are selected to reduce variation of transmittance resulted from variation of liquid crystal voltage applied to each display region. The selection of liquid crystal voltages applied to the display regions is illustrated in the following embodiments.

### The First Embodiment

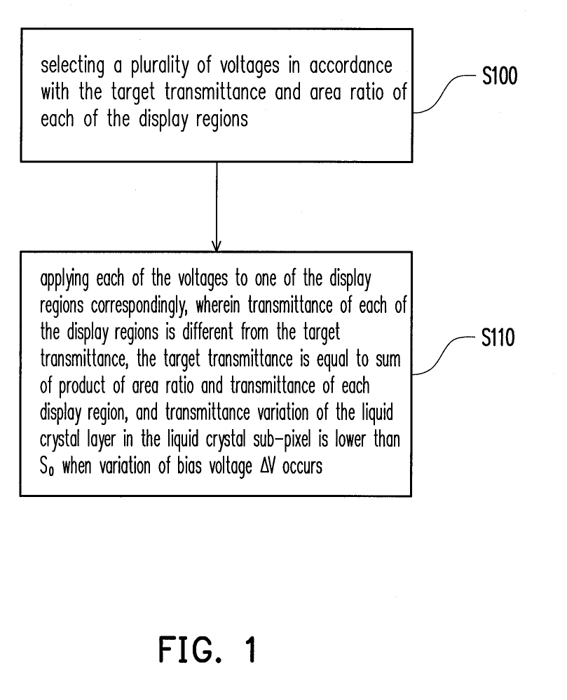

FIG. 1 is a flow chart illustrating a driving method according to the first embodiment of the present invention. Referring to FIG. 1, a driving method of this embodiment is suitable for determining a target transmittance T_{target}(n) to be displayed by a liquid crystal layer in a liquid crystal sub-pixel, wherein the liquid crystal sub-pixel has a plurality of individual display regions, the liquid crystal layer in the liquid crystal sub-pixel displays the target transmittance T_{target}(n) when liquid crystal voltage applied to each of the display regions is equal to one other and transmittance variation of liquid crystal layer in the liquid crystal sub-pixel is S₀ when variation of liquid crystal voltage ΔV_{LC} occurs. Here, liquid crystal voltage ΔV_{LC} is resulted from charged impurities or ions existed in the liquid crystal layer.

The driving method of the present invention includes the following steps. First, a plurality of liquid crystal voltages are selected in accordance with the target transmittance T_{target}(n) and area ratio of each of the display regions (step S100). Then, each of the liquid crystal voltages is applied to one of the display regions correspondingly, wherein transmittance provided by each of the display regions is different from the target transmittance T_{target}(n) (step S110). The target transmittance T_{target}(n) is equal to sum of product of area ratio and transmittance of each display region, and transmittance variation of the liquid crystal layer in the liquid crystal sub-pixel is lower than S₀ when variation of liquid crystal voltage ΔV_{LC} occurs.

Specifically, the liquid crystal sub-pixel of the present embodiment has display regions in the number of n, wherein transmittance of a liquid crystal layer within the liquid crystal sub-pixel is T_{sub-pixel} when voltage applied to each of the display regions is V₀ and transmittance variation of the liquid crystal sub-pixel is S₀ when variation of liquid crystal voltage ΔV_{LC} occurs. Here, transmittance of a liquid crystal layer within the liquid crystal sub-pixel T_{sub-pixel} is substantially equal to the target transmittance T_{target}(n). For example, in liquid crystal display panel of LCD-TV, gamma value (γ) is generally equal to 2.2. In addition, in liquid crystal display panels having 8-bits image processor, the target transmittance T_{target}(n) is related to gray-level and gamma value (γ). The relationship is expressed as following.

$${T}_{pixel} = {T}_{target} ( n ) = {( \frac{n}{255} )}^{γ}$$

In the present embodiment, the driving method includes applying a liquid crystal voltage Vₖ to each of the display regions respectively such that transmittance of the liquid crystal layer within each of the display regions is Tₖ(Vₖ), wherein 1≦k≦n and n≧2. Area of each of the display regions is aₖ such that aₖ and Tₖ(Vₖ) satisfy equation (1). In other words, the liquid crystal sub-pixel can display correct transmittance T_{sub-pixel} or T_{target}(n) when aₖ and Tₖ(Vₖ) satisfy equation (1). As shown in equation (1), the target transmittance T_{target}(n) is equal to sum of product of area aₖ and transmittance Tₖ(Vₖ) of each display region.

$$\begin{matrix}{T}_{pixel} = \frac{{\sum }_{k = 1}^{n} {a}_{k} \times {T}_{k} ( {V}_{k} )}{{\sum }_{k = 1}^{n} {a}_{k}} & ( 1 ) \\ {S}_{pixel} = \frac{{\sum }_{k = 1}^{n} {a}_{k} \times {S}_{k} ( {V}_{k} )}{{\sum }_{k = 1}^{n} {a}_{k}} < {S}_{0} & ( 2 )\end{matrix}$$

When liquid crystal voltage of each of the display regions satisfies equation (1) and variation of liquid crystal voltage ΔV_{LC} occurs, transmittance variation of each of the display regions is Sₖ(Vₖ), an overall transmittance variation of the liquid crystal layer in the liquid crystal sub-pixel is Sₚᵢₓₑₗ, as well as Sₖ(Vₖ) and Sₚᵢₓₑₗ satisfy equation (2). As shown in equation (2), when variation of liquid crystal voltage ΔV_{LC} occurs, the overall transmittance variation Sₚᵢₓₑₗ is equal to sum of product of area aₖ and transmittance variation Sₖ(Vₖ) of each display region. The overall transmittance variation Sₚᵢₓₑₗ is lower than the transmittance variation S₀.

In an embodiment of the invention, transmittance Tₖ(Vₖ) of the liquid crystal layer within some parts of the display regions is greater than T_{sub-pixel}, transmittance Tₖ(Vₖ) of the liquid crystal layer within the other parts of the display regions is lower than T_{sub-pixel}. In addition, liquid crystal voltages Vₖ (i.e. V₁, V₂, . . . , Vₙ₋₁, and Vₙ) applied to each of the display regions are different from one another, or not identical. It is noted that the driving method does not exclude applied identical liquid crystal voltages Vₖ (i.e. V₁, V₂, . . . , Vₙ₋₁, and Vₙ) to each of the display regions. In other words, the driving method which applied different liquid crystal voltages Vₖ to each of the display regions and the driving method which applied identical liquid crystal voltages Vₖ to each of the display regions can be adopted alternately when driving liquid crystal sub-pixels.

In an embodiment of the invention, areas aₖ (i.e. a₁, a₂, . . . , aₙ₋₁, and aₙ) of each of the display regions are different from one another, identical, or not identical. Additionally, in the present embodiment, voltage-transmittance curve of liquid crystal layer within the display regions are different from one another, identical, or not identical. According to experimental results and voltage-transmittance curve of liquid crystal layer, when liquid crystal voltage ΔV_{LC} applied to a display region varies 1 mV (i.e. ΔV_{LC}=1 mV), transmittance variation Sₖ(Vₖ) is lower than 0.25%. In other words, transmittance variation Sₖ(Vₖ) is lower than 0.0025/mV.

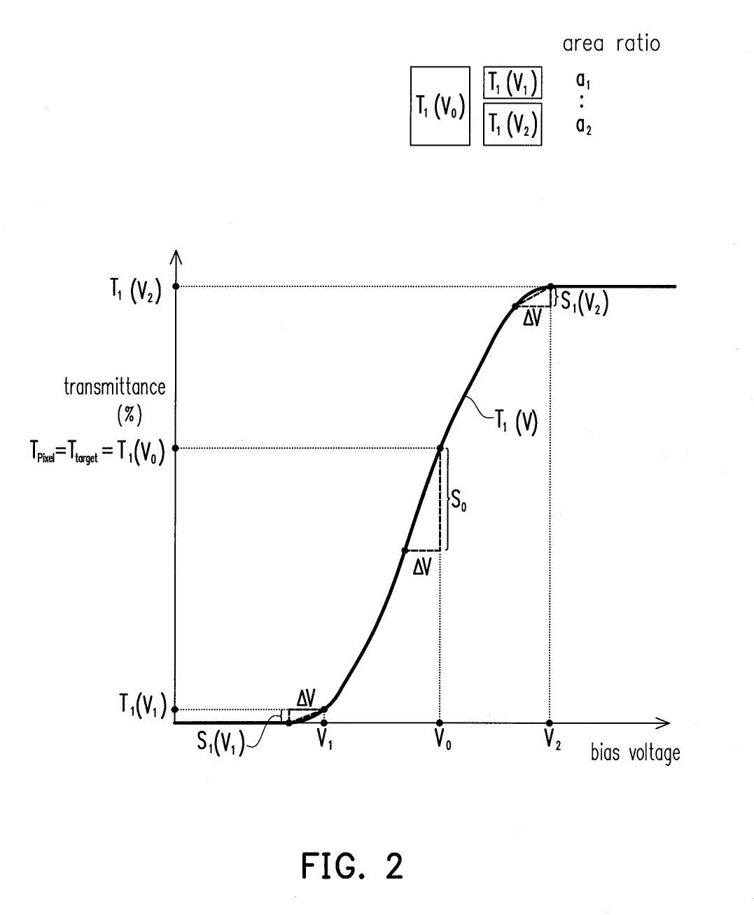

FIG. 1 is a Voltage-Transmittance curve illustrating relationship between voltage V₀ and liquid crystal voltages Vₖ (i.e. liquid crystal voltage V₁ and liquid crystal voltage V₂). Referring to FIG. 2, a normally black liquid crystal is described for illustration, wherein Voltage-Transmittance curves of the liquid crystal layer in every display regions are identical.

As shown in FIG. 2, voltage V₀ is between liquid crystal voltage V₁ and liquid crystal voltage V₂. In the present embodiment, liquid crystal voltage V₁ and liquid crystal voltage V₂ satisfy equation (1) and equation (2). In addition, liquid crystal voltage V₁ may be a liquid crystal voltage corresponding to the lowest transmittance (e.g. 0%), liquid crystal voltage V₂ may be a liquid crystal voltage corresponding to the highest transmittance (e.g. 100%).

When n=2 and a1≠a2, equation (1) and equation (2) are simplified as followings:

$$\begin{matrix}{T}_{pixel} = \frac{{a}_{1} \times {T}_{1} ( {V}_{1} ) + {a}_{2} \times {T}_{1} ( {V}_{2} )}{{a}_{1} + {a}_{2}} \\ = ( \frac{{a}_{1}}{{a}_{1} + {a}_{2}} ) \times {T}_{1} ( {V}_{1} ) + ( \frac{{a}_{2}}{{a}_{1} + {a}_{2}} ) \times {T}_{1} ( {V}_{2} )\end{matrix}$$

$$\begin{matrix}{S}_{pixel} = \frac{{a}_{1} \times {S}_{1} ( {V}_{1} ) + {a}_{2} \times {S}_{1} ( {V}_{2} )}{{a}_{1} + {a}_{2}} \\ = ( \frac{{a}_{1}}{{a}_{1} + {a}_{2}} ) \times {S}_{1} ( {V}_{1} ) + ( \frac{{a}_{2}}{{a}_{1} + {a}_{2}} ) \times {S}_{1} ( {V}_{2} ) < {S}_{0}\end{matrix}$$

$$\frac{{a}_{1}}{{a}_{1} + {a}_{2}} and \frac{{a}_{2}}{{a}_{1} + {a}_{2}}$$

represent area ratio of two display regions respectively, while T₁(V₁and T₁(V₂) represent transmittance corresponding to liquid crystal voltage V₁ and liquid crystal voltage V₂ respectively.

When n=2 and a1=a2, equation (1) and equation (2) are further simplified as followings:

$${T}_{pixel} = \frac{{T}_{1} ( {V}_{1} ) + {T}_{1} ( {V}_{2} )}{2}$$

$${S}_{pixel} = \frac{{S}_{1} ( {V}_{1} ) + {S}_{1} ( {V}_{2} )}{2} < {S}_{0}$$

### The Second Embodiment

Referring to equation (1) and equation (2) described in the first embodiment, when n=2, a1≠a2, and Voltage-Transmittance curves of the liquid crystal layer in every display regions are not identical, equation (1) and equation (2) are simplified as followings:

$$\begin{matrix}{T}_{pixel} = \frac{{a}_{1} \times {T}_{1} ( {V}_{1} ) + {a}_{2} \times {T}_{2} ( {V}_{2} )}{{a}_{1} + {a}_{2}} \\ = ( \frac{{a}_{1}}{{a}_{1} + {a}_{2}} ) \times {T}_{1} ( {V}_{1} ) + ( \frac{{a}_{2}}{{a}_{1} + {a}_{2}} ) \times {T}_{2} ( {V}_{2} )\end{matrix}$$

$$\begin{matrix}{S}_{pixel} = \frac{{a}_{1} \times {S}_{1} ( {V}_{1} ) + {a}_{2} \times {S}_{2} ( {V}_{2} )}{{a}_{1} + {a}_{2}} \\ = ( \frac{{a}_{1}}{{a}_{1} + {a}_{2}} ) \times {S}_{1} ( {V}_{1} ) + ( \frac{{a}_{2}}{{a}_{1} + {a}_{2}} ) \times {S}_{2} ( {V}_{2} ) < {S}_{0}\end{matrix}$$

$$\frac{{a}_{1}}{{a}_{1} + {a}_{2}} and \frac{{a}_{2}}{{a}_{1} + {a}_{2}}$$

represent area ratio of two display regions respectively, while T₁(V₁) and T₂(V₂) represent transmittance corresponding to liquid crystal voltage V₁ and liquid crystal voltage V₂ respectively.

When n=2, a1=a2, and Voltage-Transmittance curves of the liquid crystal layer in every display regions are not identical, equation (1) and equation (2) are simplified as followings:

$${T}_{pixel} = \frac{{T}_{1} ( {V}_{1} ) + {T}_{2} ( {V}_{2} )}{2}$$

$${S}_{pixel} = \frac{{S}_{1} ( {V}_{1} ) + {S}_{2} ( {V}_{2} )}{2} < {S}_{0}$$

As shown in the present embodiment, Voltage-Transmittance curves of the liquid crystal layer in display regions are not identical because structural designs of display regions are not identical. The concept of the present invention is still applied when Voltage-Transmittance curves of the liquid crystal layer in display regions are not identical.

### The Third Embodiment

Since transmittance of liquid crystal layer in liquid crystal sub-pixel and luminance of gray-level displayed by liquid crystal sub-pixel is related, the present embodiment selects liquid crystal voltages applied to display regions in accordance with luminance of gray-level and variation of luminance of gray-level.

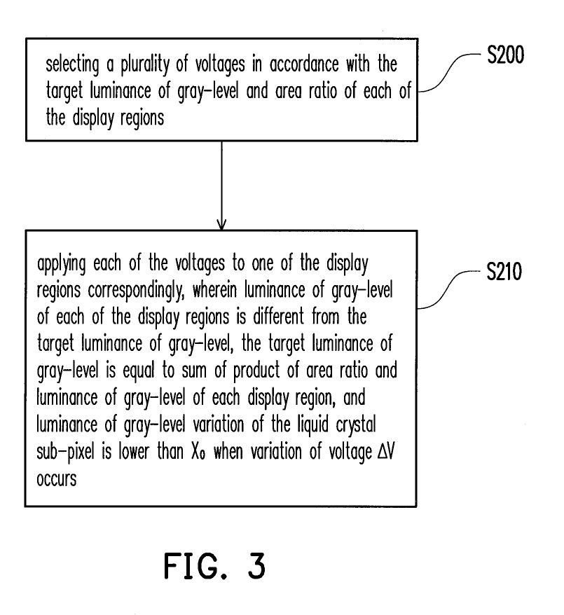

FIG. 3 is a flow chart illustrating a driving method according to the third embodiment of the present invention. Referring to FIG. 3, a driving method of this embodiment is suitable for determining a target luminance of gray-level L_{target}(n) to be displayed by a liquid crystal sub-pixel, wherein the liquid crystal sub-pixel has a plurality of individual display regions, the liquid crystal layer in the liquid crystal sub-pixel displays the target luminance of gray-level L_{target}(n) when liquid crystal voltage applied to each of the display regions is equal to one other and luminance of gray-level variation of the liquid crystal sub-pixel is X₀ when variation of liquid crystal voltage ΔV_{LC} occurs. Here, liquid crystal voltage ΔV_{LC} is resulted from charged impurities or ions existed in the liquid crystal layer.

The driving method of the present invention includes the following steps. First, a plurality of liquid crystal voltages are selected in accordance with the target luminance of gray-level L_{target}(n) and area ratio of each of the display regions (step S200). Then, each of the liquid crystal voltages is applied to one of the display regions correspondingly, wherein luminance of gray-levle provided by each of the display regions is different from the target luminance of gray-level L_{target}(n)(step S210). The target luminance of gray-level L_{target}(n) is equal to sum of product of area ratio and transmittance of each display region, and transmittance variation of the liquid crystal layer in the liquid crystal sub-pixel is lower than X₀ when variation of liquid crystal voltage ΔV_{LC} occurs.

Specifically, the liquid crystal sub-pixel of the present embodiment has display regions in the number of n, wherein luminance of gray-level of the liquid crystal sub-pixel is Lₚᵢₓₑₗ when voltage applied to each of the display regions is V₀ and luminance of gray-level variation of the liquid crystal sub-pixel is X₀ when variation of liquid crystal voltage ΔV_{LC} occurs. Here, luminance of gray-level of the liquid crystal sub-pixel Lₚᵢₓₑₗ is substantially equal to the target luminance of gray-level L_{target}(n).

In the present embodiment, the driving method includes applying a liquid crystal voltage Vₖ to each of the display regions respectively such that luminance of gray-level of each of the display regions is Lₖ(Vₖ), wherein 1≦k≦n and n≧2. Area of each of the display regions is aₖ such that aₖ and Lₖ(Vₖ) satisfy equation (3). In other words, the liquid crystal sub-pixel can display correct luminance of gray-level Lₚᵢₓₑₗ or L_{target}(n) when aₖ and Tₖ(Vₖ) satisfy equation (3). As shown in equation (3), the target luminance of gray-level L_{target}(n) is equal to sum of product of area aₖ and luminance of gray-level Lₖ(Vₖ) of each display region.

$$\begin{matrix}{L}_{pixel} = \frac{{\sum }_{k = 1}^{n} {a}_{k} \times {L}_{k} ( {V}_{k} )}{{\sum }_{k = 1}^{n} {a}_{k}} & ( 3 ) \\ {X}_{pixel} = \frac{{\sum }_{k = 1}^{n} {a}_{k} \times {X}_{k} ( {V}_{k} )}{{\sum }_{k = 1}^{n} {a}_{k}} < {X}_{0} & ( 4 )\end{matrix}$$

when liquid crystal voltage of each of the display regions satisfies equation (3) and variation of liquid crystal voltage ΔV_{LC} occurs, luminance of gray-level variation of each of the display regions is Xₖ(Vₖ), an overall luminance of gray-level variation of the liquid crystal layer in the liquid crystal sub-pixel is Xₚᵢₓₑₗ, as well as Xₖ(Vₖ) and Xₚᵢₓₑₗ satisfy equation (4). As shown in equation (4), when variation of liquid crystal voltage ΔV_{LC} occurs, the overall luminance of gray-level variation Xₚᵢₓₑₗ is equal to sum of product of area aₖ and luminance of gray-level Xₖ(Vₖ) of each display region. The overall luminance of gray-level variation Xₚᵢₓₑₗ is lower than the transmittance variation X₀.

In an embodiment of the invention, luminance of gray-level Lₖ(Vₖ) of some parts of the display regions is greater than Lₚᵢₓₑₗ, luminance of gray-level Lₖ(Vₖ) of the other parts of the display regions is lower than Lₚᵢₓₑₗ. In addition, liquid crystal voltages Vₖ (i.e. V₁, V₂, . . . , Vₙ₋₁, and Vₙ) applied to each of the display regions are different from one another, or not identical. It is noted that the driving method does not exclude applied identical liquid crystal voltages Vₖ (i.e. V₁, V₂, . . . , Vₙ₋₁, and Vₙ) to each of the display regions. In other words, the driving method which applied different liquid crystal voltages Vₖ to each of the display regions and the driving method which applied identical liquid crystal voltages Vₖ to each of the display regions can be adopted alternately when driving liquid crystal sub-pixels.

In an embodiment of the invention, areas aₖ (i.e. a₁, a₂, . . . , aₙ₋₁, and aₙ) of each of the display regions are different from one another, identical, or not identical. Additionally, in the present embodiment, voltage-transmittance curve of liquid crystal layer within the display regions are different from one another, identical, or not identical.

When n=2 and a1≠a2, equation (3) and equation (4) are simplified as followings:

$$\begin{matrix}{L}_{pixel} = \frac{{a}_{1} \times {L}_{1} ( {V}_{1} ) + {a}_{2} \times {L}_{1} ( {V}_{2} )}{{a}_{1} + {a}_{2}} \\ = ( \frac{{a}_{1}}{{a}_{1} + {a}_{2}} ) \times {L}_{1} ( {V}_{1} ) + ( \frac{{a}_{2}}{{a}_{1} + {a}_{2}} ) \times {L}_{1} ( {V}_{2} )\end{matrix}$$

$$\begin{matrix}{X}_{pixel} = \frac{{a}_{1} \times {X}_{1} ( {V}_{1} ) + {a}_{2} \times {X}_{1} ( {V}_{2} )}{{a}_{1} + {a}_{2}} \\ = ( \frac{{a}_{1}}{{a}_{1} + {a}_{2}} ) \times {X}_{1} ( {V}_{1} ) + ( \frac{{a}_{2}}{{a}_{1} + {a}_{2}} ) \times {X}_{1} ( {V}_{2} ) < {X}_{0}\end{matrix}$$

$$\frac{{a}_{1}}{{a}_{1} + {a}_{2}} and \frac{{a}_{2}}{{a}_{1} + {a}_{2}}$$

represent area ratio of two display regions respectively, while L₁(V₁) and L₁(V₂) represent luminance of gray-level corresponding to liquid crystal voltage V₁ and liquid crystal voltage V₂ respectively.

When n=2 and a1=a2, equation (3) and equation (4) are further simplified as followings:

$${L}_{pixel} = \frac{{L}_{1} ( {V}_{1} ) + {L}_{1} ( {V}_{2} )}{2}$$

$${X}_{pixel} = \frac{{X}_{1} ( {V}_{1} ) + {X}_{1} ( {V}_{2} )}{2} < {X}_{0}$$

### The Fourth Embodiment

Referring to equation (3) and equation (4) described in the third embodiment, when n=2, a1≠a2, and Voltage-luminance of gray level curves of display regions are not identical, equation (3) and equation (4) are simplified as followings:

$$\begin{matrix}{L}_{pixel} = \frac{{a}_{1} \times {L}_{1} ( {V}_{1} ) + {a}_{2} \times {L}_{2} ( {V}_{2} )}{{a}_{1} + {a}_{2}} \\ = ( \frac{{a}_{1}}{{a}_{1} + {a}_{2}} ) \times {L}_{1} ( {V}_{1} ) + ( \frac{{a}_{2}}{{a}_{1} + {a}_{2}} ) \times {L}_{2} ( {V}_{2} )\end{matrix}$$

$$\begin{matrix}{X}_{pixel} = \frac{{a}_{1} \times {X}_{1} ( {V}_{1} ) + {a}_{2} \times {X}_{2} ( {V}_{2} )}{{a}_{1} + {a}_{2}} \\ = ( \frac{{a}_{1}}{{a}_{1} + {a}_{2}} ) \times {X}_{1} ( {V}_{1} ) + ( \frac{{a}_{2}}{{a}_{1} + {a}_{2}} ) \times {X}_{2} ( {V}_{2} ) < {X}_{0}\end{matrix}$$

$$\frac{{a}_{1}}{{a}_{1} + {a}_{2}} and \frac{{a}_{2}}{{a}_{1} + {a}_{2}}$$

represent area ratio of two display regions respectively, while L₁(V₁) and L₂(V₂) represent luminance of gray-level corresponding to liquid crystal voltage V₁ and liquid crystal voltage V₂ respectively.

When n=2, a1=a2, and Voltage-Luminance of Gray level curves of display regions are not identical, equation (3) and equation (4) are further simplified as followings:

$${L}_{pixel} = \frac{{L}_{1} ( {V}_{1} ) + {L}_{2} ( {V}_{2} )}{2}$$

$${X}_{pixel} = \frac{{X}_{1} ( {V}_{1} ) + {X}_{2} ( {V}_{2} )}{2} < {X}_{0}$$

As shown in the present embodiment, Voltage-luminance of Gray level curves of display regions are not identical because structural designs of display regions are not identical. The concept of the present invention is still applied when Voltage-Transmittance curves of the liquid crystal layer in display regions are not identical.

By selecting liquid crystal voltages in accordance with the target luminance of gray-level (or the target transmittance) to be displayed and area ratio of each display region in the liquid crystal sub-pixel and applies each liquid crystal voltage to one of the display regions correspondingly, the liquid crystal sub-pixel of the present invention can effectively reduce image sticking problem.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving method of a liquid crystal sub-pixel having display regions in the number of n, wherein transmittance of a liquid crystal layer within the liquid crystal sub-pixel is T_{sub-pixel} when voltage applied to each of the display regions is V₀ and transmittance variation of the liquid crystal sub-pixel is S₀ when variation of liquid crystal voltage ΔV_{LC} occurs, the driving method comprises:
applying a liquid crystal voltage Vₖ to each of the display regions respectively such that transmittance of the liquid crystal layer within each of the display regions is Tₖ(Vₖ), wherein 1≦k≦n, n≧2, and area of each of the display regions is aₖ such that aₖ and Tₖ(Vₖ) satisfy equation (1);
$$\begin{matrix}{T}_{pixel} = \frac{{\sum }_{k = 1}^{n} {a}_{k} \times {T}_{k} ( {V}_{k} )}{{\sum }_{k = 1}^{n} {a}_{k}} ; & ( 1 ) \\ {S}_{pixel} = \frac{{\sum }_{k = 1}^{n} {a}_{k} \times {S}_{k} ( {V}_{k} )}{{\sum }_{k = 1}^{n} {a}_{k}} < {S}_{0} ; & ( 2 )\end{matrix}$$
when liquid crystal voltage of each of the display regions satisfies equation (1) and variation of liquid crystal voltage ΔV_{LC} occurs, transmittance variation of the liquid crystal layer in each of the display regions is Sₖ(Vₖ), an overall transmittance variation of the liquid crystal layer in the liquid crystal sub-pixel is Sₚᵢₓₑₗ, as well as Sₖ(Vₖ) and Sₚᵢₓₑₗ satisfy equation (2).

2. The driving method of claim 1, wherein liquid crystal voltages V₁, V₂, . . . , Vₙ₋₁, and Vₙ applied to each of the display regions are different from.

3. The driving method of claim 1, wherein liquid crystal voltages V₁, V₂, . . . , Vₙ₋₁, and Vₙ applied to each of the display regions are not identical.

4. The driving method of claim 1, wherein areas a₁, a₂, . . . , aₙ₋₁, and aₙ of each of the display regions are different from one another.

5. The driving method of claim 1, wherein areas a₁, a₂, . . . , aₙ₋₁, and aₙ of each of the display regions are identical.

6. The driving method of claim 1, wherein areas a₁, a₂, . . . , aₙ₋₁, and aₙ of each of the display regions are not identical.

7. The driving method of claim 1, wherein transmittance Tₖ(Vₖ) of the liquid crystal layer within parts of the display regions is greater than T_{sub-pixel}, transmittance Tₖ(Vₖ) of the liquid crystal layer within the other parts of the display regions is lower than T_{sub-pixel}.

8. The driving method of claim 1, wherein the liquid crystal sub-pixel comprises a transmissive liquid crystal sub-pixel, reflective liquid crystal sub-pixel, or a transflective liquid crystal sub-pixel.

9. The driving method of claim 1, wherein voltage-transmittance curve of liquid crystal layer within the display regions are different from one another.

10. The driving method of claim 1, wherein voltage-transmittance curve of liquid crystal layer within the display regions are identical.

11. The driving method of claim 1, wherein voltage-transmittance curve of liquid crystal layer within the display regions are not identical.

12. The driving method of claim 1, wherein transmittance variation Sₖ(Vₖ) is lower than 0.0025/mV when liquid crystal voltage ΔV_{LC} applied to a display region varies 1 mV.

13. A driving method of a liquid crystal sub-pixel having display regions in the number of n, wherein luminance of gray-level displayed by the liquid crystal sub-pixel is Lₚᵢₓₑₗ when voltage applied to each of the display regions is V₀ and luminance of gray-level variation of the liquid crystal sub-pixel is X₀ when variation of liquid crystal voltage ΔV_{LC} occurs, the driving method comprises:
applying a liquid crystal voltage Vₖ to each of the display regions respectively such that luminance of gray-level of each of the display regions is Lₖ(Vₖ), wherein 1≦k≦n, n≧2, and area of each of the display regions is aₖ such that aₖ and Lₖ(Vₖ) satisfy equation (3);
$$\begin{matrix}{L}_{pixel} = \frac{{\sum }_{k = 1}^{n} {a}_{k} \times {L}_{k} ( {V}_{k} )}{{\sum }_{k = 1}^{n} {a}_{k}} ; & ( 3 ) \\ {X}_{pixel} = \frac{{\sum }_{k = 1}^{n} {a}_{k} \times {X}_{k} ( {V}_{k} )}{{\sum }_{k = 1}^{n} {a}_{k}} < {X}_{0} ; & ( 4 )\end{matrix}$$
when liquid crystal voltage of each of the display regions satisfies equation (3) and variation of liquid crystal voltage ΔV_{LC} occurs, luminance of gray-level variation of each of the display regions is Xₖ(Vₖ), an overall luminance of gray-level variation of the liquid crystal layer in the liquid crystal sub-pixel is Xₚᵢₓₑₗ, as well as Xₖ(Vₖ) and Xₚᵢₓₑₗ satisfy equation (4).

14. The driving method of claim 13, wherein liquid crystal voltages V₁, V₂, . . . , Vₙ₋₁, and Vₙ applied to each of the display regions are different from.

15. The driving method of claim 13, wherein liquid crystal voltages V₁, V₂, . . . , Vₙ₋₁, and Vₙ applied to each of the display regions are not identical.

16. The driving method of claim 13, wherein areas a₁, a₂, . . . , aₙ₋₁, and aₙ of each of the display regions are different from one another.

17. The driving method of claim 13, wherein areas a₁, a₂, . . . , aₙ₋₁, and aₙ of each of the display regions are identical.

18. The driving method of claim 13, wherein areas a₁, a₂, . . . , aₙ₋₁, and aₙ of each of the display regions are not identical.

19. The driving method of claim 13, wherein luminance of gray-level Lₖ(Vₖ) of parts of the display regions is greater than Lₚᵢₓₑₗ, and luminance of gray-level Lₖ(Vₖ) of the other parts of the display regions is lower than Lₚᵢₓₑₗ.

20. The driving method of claim 13, wherein the liquid crystal sub-pixel comprises a transmissive liquid crystal sub-pixel, reflective liquid crystal sub-pixel, or a transflective liquid crystal sub-pixel.

21. The driving method of claim 13, wherein voltage- luminance of gray level curve of the display regions are different from one another.

22. The driving method of claim 13, wherein voltage- luminance of gray level curve of the display regions are identical.

23. The driving method of claim 13, wherein voltage- luminance of gray level curve of the display regions are not identical.

24. A driving method for determining a target transmittance of a liquid crystal layer in a liquid crystal sub-pixel is provided, wherein the liquid crystal sub-pixel has a plurality of display regions, the liquid crystal layer in the liquid crystal sub-pixel displays the target transmittance when liquid crystal voltage applied to each of the display regions is equal to one other and transmittance variation of liquid crystal layer in the liquid crystal sub-pixel is S₀ when variation of liquid crystal voltage ΔV_{LC} occurs, the driving method comprises:
selecting a plurality of liquid crystal voltages in accordance with the target transmittance and area ratio of each of the display regions; and
applying each of the liquid crystal voltages to one of the display regions correspondingly, wherein transmittance of each of the display regions is different from the target transmittance, the target transmittance is equal to sum of product of area ratio and transmittance of each display region, and transmittance variation of the liquid crystal layer in the liquid crystal sub-pixel is lower than S₀ when variation of liquid crystal voltage ΔV_{LC} occurs.

25. A driving method for determining a target luminance of gray-level of a liquid crystal sub-pixel is provided, wherein the liquid crystal sub-pixel has a plurality of display regions, the liquid crystal sub-pixel displays the target luminance of gray-level when liquid crystal voltage applied to each of the display regions is equal to one other and luminance of gray-level variation of the liquid crystal sub-pixel is X₀ when variation of liquid crystal voltage ΔV_{LC} occurs, the driving method comprises:selecting a plurality of liquid crystal voltages in accordance with the target luminance of gray-level and area ratio of each of the display regions; and
applying each of the liquid crystal voltages to one of the display regions correspondingly, wherein luminance of gray-level of each of the display regions is different from the target luminance of gray-level, the target luminance of gray-level is equal to sum of product of area ratio and luminance of gray-level of each display region, and luminance of gray-level variation of the liquid crystal sub-pixel is lower than X₀ when variation of liquid crystal voltage ΔV_{LC} occurs.
